(19) United States
(12) Patent Application Publication
(10) Pub. No.: US 2006/0043197 A1
(43) Pub. Date: Mar. 2, 2006

(54) Carrier facilitating radio-frequency identification (RFID) operation in a semiconductor fabrication system

(76) Inventors: Yung Cheng Chang, Tainan Shien (TW); Hsieh Shyh Fu, Jundong Township (TW); Hung Ti Hsieh, Jhubei City (TW); Meng Shiun Chan, Chiayi City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/930,111

(22) Filed: Aug. 31, 2004

(51) Int. Cl. G06K 19/06; G05B 19/00; G08B 13/14; G08B 23/00

(52) U.S. Cl. 235/492; 340/573.4; 340/5.8; 340/572.8

(57) ABSTRACT

A carrier for radio-frequency identification (RFID) operation in a fab. A carrier body comprises a plate inscribed with permanent information corresponding to the carrier. A RFID tag is mounted on the carrier body, and stores the permanent information.

### BACKGROUND

The invention relates to manufacturing control in a semiconductor manufacturing environment, and particularly to an apparatus facilitating RFID operation therein.

Integrated circuit (commonly abbreviated as “IC”) dies are manufactured by performing a number of steps on a semiconductor wafer in a fabrication system (commonly abbreviated as “fab”). In a conventional fab, a wafer carrier is equipped with a smart tag storing information pertaining to the carrier (such as carrier identification number and carrier clean due date), wafers loaded therein (such as lot number), and process for the loaded wafers (such as recipe information). Information stored in a smart tag is retrieved by a tag reader mounted on a load port of a processing tool. The retrieved information is relayed to a control center, and the control center issues commands accordingly to direct operation of the processing tool. A carrier attached with a smart tag is further equipped with a display screen, providing visible access for operators to the information stored in the smart tag.

Recently, the radio-frequency identification (RFID) technique has been introduced into semiconductor manufacturing environments. For example, in a 300-mm fab, wafers are enclosed in carriers referred to as front-opening unified pods (FOUPs), wherein a RFID tag storing corresponding carrier identification information is attached to each FOUP. Information stored in a RFID tag is retrieved by a RFID reader mounted on a load port of a processing tool. The retrieved information is then relayed to a control center, and the control center issues commands accordingly to direct operation of the processing tool. Information stored in a RFID tag, however, cannot be recognized visually by an operator. Thus, a handheld RFID reader enabling operators to recognize the carrier ID stored in the RFID tag is desirable. Generally, there are thousands or more handheld RFID readers in a certain fab. The enormous number of handheld RFID readers adds additional cost to RFID operation. Additional costs are also incurred by managing this portable equipment.

Hence, there is a need for an apparatus that addresses problems arising from the existing technology and facilitates RFID operation.

### SUMMARY

An embodiment of the invention provides a carrier facilitating radio-frequency identification (RFID) operation in a fab. The carrier comprises a carrier body and a RFID tag mounted thereon. The carrier body comprises a plate inscribed with permanent information corresponding to the carrier, wherein the permanent information is stored in the RFID tag.

Another embodiment of the invention provides a processing system. The processing system comprises a processing tool, a carrier, and a controller center. The processing tool, used to process a workpiece, is mounted with a RFID reader. The carrier carries a workpiece processed in the processing system. The carrier comprises a carrier body and a RFID tag mounted thereon. The carrier body comprises a plate inscribed with permanent information corresponding to the carrier, wherein the permanent information is stored in the RFID tag. The control center provides fabrication information according to the permanent information and controls the processing tool accordingly.

A detailed description is given in the following embodiments with reference to the accompanying drawings.

### BRIEF DESCRIPTION OF THE DRAWINGS

Embodiments of the invention can be more fully understood by reading the subsequent detailed description and examples with references made to the accompanying drawings, wherein:

FIG. 1 is a schematic view of a processing system according to embodiments of the invention; and

FIG. 2 is a schematic view of a transport system according to embodiments of the invention.

### DETAILED DESCRIPTION

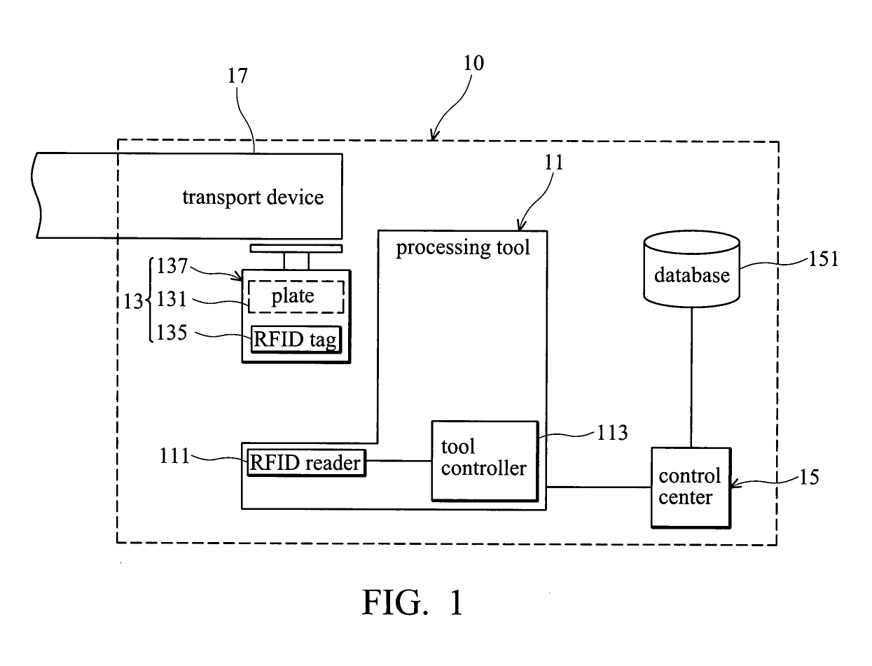

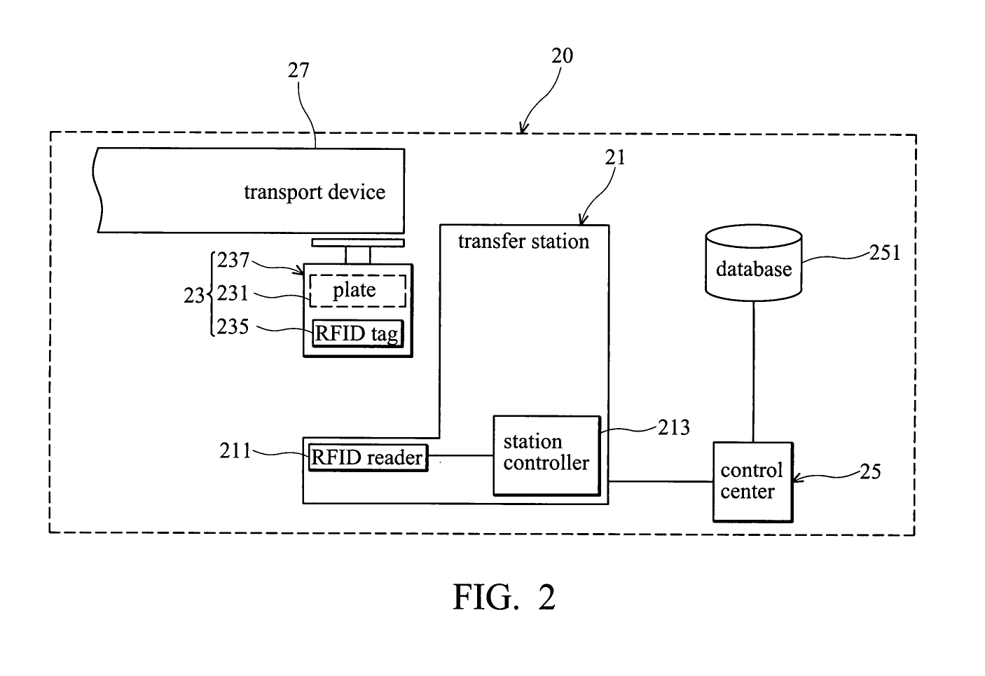

The invention is now described with reference to FIGS. 1 and 2, which in general relate to manufacturing control in a semiconductor manufacturing environment.

FIG. 1 is a schematic view of a processing system according to embodiments of the invention. A processing system 10 performs manufacturing steps for processing semiconductor products. The processing system 10 comprises a processing tool 11, a carrier 13, a control center 15, and a transport device 17.

Processing tool 11 performs manufacturing steps to fabricate wafers. Processing tool 11 is equipped with a load port mounted with a RFID reader 111. Wafers are loaded in the processing tool 11 via the load port.

Carrier 13 holds wafers transferred between stations in processing system 10. Carrier 13 is transported via transport device 17. According to this embodiment, carrier 13 is a front opening unified pod (FOUP), and transport device 17 is an overhead hoist transport (OHT) system. Carrier 13 comprises a carrier body 137 and a RFID tag 135 mounted thereon. The RFID tag 135 stores information for identifying the carrier 13, such as a carrier identification number. The carrier body 137 comprises a plate 131 inscribed with the carrier identification number.

When carrier 13 is transported to processing tool 11, the carrier identification number stored in RFID tag 135 is received by RFID reader 111. The carrier identification number is then relayed to control center 15 via a tool controller 113. According to this embodiment, control center 15 is a computer integrated manufacturing (CIM) system. Control center 15 receives the carrier identification number and retrieves processing parameters and other information pertaining to operation of the processing tool 11 from a database 151. The retrieved information is then sent to tool controller 113, thus, tool controller 113 controls processing tool 11 accordingly. An operator can read the inscribed carrier identification number and make any necessary adjustments.

Additionally, carrier 13 may hold reticles transferred between stations in processing system 10. In this case, carrier 13 is a reticle pod, and processing tool 11 is a work station performs photolithography processes.

Another embodiment of the invention provides a transport system implementing RFID tags to facilitate transport control. A transport system 20 transfers wafers between separate processing systems, such as fabs. The transport system 20 comprises a transfer station 21, a carrier 23, a control center 25, and a transport device 27.

Transfer station 21 relays wafers between fabs. Transfer station 21 is equipped with a load port mounted with a RFID reader 211. Wafers are loaded in transfer station 21 via the load port.

Carrier 23 holds wafers transferred between fabs. Carrier 23 is transported via transport device 27. According to this embodiment, carrier 23 is a front opening shipping box (FOSB). Carrier 23 comprises a carrier body 237 and a RFID tag 235 mounted thereon. The RFID tag 235 stores information for identifying the carrier 23, such as a carrier identification number. The carrier body 237 is a front opening box, comprising a plate 231 inscribed with the carrier identification number.

When carrier 23 is transported to transport station 21, the carrier identification number stored in RFID tag 235 is received by RFID reader 211. The carrier identification number is then relayed to control center 25 via a station controller 213. Control center 25 receives the carrier identification number and retrieves information pertaining to operation of the transport station 21 from a database 251. The retrieved information is then sent to station controller 213, thus station controller 213 controls transport station 21 accordingly. An operator can read the inscribed carrier identification number and make any necessary adjustments to the transport operation.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A carrier for radio-frequency identification (RFID) operation in a fab, comprising:
a carrier body, comprising a plate inscribed with permanent information corresponding to the carrier; and
a RFID tag, mounted on the carrier body, storing the permanent information.

2. The carrier of claim 1, wherein the carrier is used for holding at least one wafer.

3. The carrier of claim 2, wherein the carrier is a front opening unified pod (FOUP).

4. The carrier of claim 2, wherein the carrier is a front opening shipping box (FOSB).

5. The carrier of claim 1, wherein the carrier is a reticle pod.

6. The carrier of claim 1, wherein the permanent information is carrier identification information.

7. A processing system, comprising:
a station mounted with a RFID reader;
a carrier, carrying a workpiece processed in the processing system, comprising:
a carrier body, comprising a plate inscribed with permanent information corresponding to the carrier; and
a RFID tag, mounted on the carrier body, storing the permanent information; and
a control center, providing processing information according to the permanent information and directing operation of the station accordingly.

8. The processing system of claim 7, wherein the carrier is loaded with at least one wafer.

9. The processing system of claim 8, wherein the carrier is a front opening unified pod (FOUP).

10. The processing system of claim 8, wherein the carrier is a front opening shipping box (FOSB).

11. The processing system of claim 7, wherein the carrier is used for holding at least one reticle.

12. The processing system of claim 7, wherein the permanent information is carrier identification information.

13. The processing system of claim 7, wherein the station is a processing tool fabricating the a workpiece.

14. The processing system of claim 7, wherein the station is a stocking station storing the a workpiece.
